(19) United States
(12) Patent Application Publication
(10) Pub. No.: US 2011/0295897 A1
(43) Pub. Date: Dec. 1, 2011

(54) QUERY CORRECTION PROBABILITY BASED ON QUERY-CORRECTION PAIRS

(75) Inventors: Jianfeng Gao, Kirkland, WA (US); Christopher B. Quirk, Seattle, WA (US); Daniel Micol Ponce, Munich (DE); Andreas Bode, Munich (DE); Xu Sun, Tokyo (JP)

(73) Assignee: Microsoft Corporation, Redmond, WA (US)

(21) Appl. No.: 12/790,996

(22) Filed: Jun. 1, 2010

(51) Int. Cl. G06F 17/30

(52) U.S. Cl. 707/780; 707/E17.079

(57) ABSTRACT

Query-correction pairs can be extracted from search log data. Each query-correction pair can include an original query and a follow-up query, where the follow-up query meets one or more criteria for being identified as a correction of the original query, such as an indication of user input indicating the follow-up query is a correction for the original query. The query-correction pairs can be segmented to identify bi-phrases in the query-correction pairs. Probabilities of corrections between the bi-phrases can be estimated based on frequencies of matches in the query-correction pairs. Identifications of the bi-phrases and representations of the probabilities of those bi-phrases can be stored in a probabilistic model data structure.

### BACKGROUND

Spelling errors in search queries often make it difficult for search engines to find relevant documents. However, unlike spelling errors in regular written text, spelling errors in search queries can be difficult to correct using dictionary-based approaches. This is because search queries often include words that are not well-established in the language, such as proper nouns and names. Various approaches have been taken to correct spelling in search queries, with varying degrees of success.

### SUMMARY

Whatever the advantages of previous query correction tools and techniques, they have neither recognized the tools and techniques described and claimed herein, nor the advantages produced by such tools and techniques.

In one embodiment, the tools and techniques can include extracting query-correction pairs from search log data based on criteria, which can include for each query-correction pair an indication of an original query in the pair, an indication of a follow-up query in the pair, and an indication of user input indicating the follow-up query is a correction for the original query. A follow-up query can be a query immediately following the original query, or the follow-up may be a later query, such as a later revision (e.g., a final revision in a string of revisions) of the original query. Also, the original query need not be the first query entered; the original query may be a later query, so long as it is followed by the follow-up query. The query-correction pairs can be analyzed to generate a probabilistic model (such as a phrase-based error model in a phrase table, which may include pairs of phrases and probability values between the phrases), which may be used in a spelling correction system. A probability value between a new query and a correction candidate for the new query can be estimated using the probabilistic model. As used herein, queries refer to search queries. Additionally, probability is considered to be an estimated or predicted probability based on one or more predictors. A probability value is a value that varies as one or more such predictors vary. Such probabilities and probability values may not be equal to or proportional to actual probabilities.

In another embodiment of the tools and techniques, query-correction pairs can be extracted from search log data. Each query-correction pair can include an original query and a follow-up query, where the follow-up query meets one or more criteria for being identified as a correction of the original query. The query-correction pairs can be segmented to identify bi-phrases in the query-correction pairs. One or more of the bi-phrases can include multiple words in one or more of its phrases. Probabilities of corrections between the bi-phrases in the query-correction pairs can be estimated based on frequencies of matches in the query-correction pairs. Identifications of the bi-phrases and representations of the probabilities of those bi-phrases can be stored in a probabilistic model data structure.

As used herein, segmenting a query and/or correction refers to analyzing the query/correction to identify one or more phrases into which the query/correction can be divided according to a technique, although in some cases the technique may result in one or more of the analyzed queries/corrections being identified as a single phrase segment. As used herein, a bi-phrase is a pair of matched phrases such as a pair of phrases with one phrase from a query and one phrase from a correction (either the whole query or correction, or part of the query or correction). The phrases in a bi-phrase may include one word or multiple words. As used herein, a word is a string of characters not separated by a space.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described embodiments may be implemented.

FIG. 2 is a schematic diagram of a query correction probability system and environment.

FIG. 3 is a flowchart of a query correction probability technique.

FIG. 4 is a flowchart of another query correction probability technique.

### DETAILED DESCRIPTION

Embodiments described herein are directed to techniques and tools related to query correction probabilities based on query-correction pairs extracted from search logs. Improvements may result from the use of various techniques and tools separately or in combination.

Such techniques and tools may include extracting query-correction pairs from search log data. Each query-correction pair can include an original query and a follow-up query. Criteria can be used to identify the query-correction pairs for extraction. For example, a pair can be identified if there is an indication of user input selecting the follow-up query as a correction for the original query (e.g., by selecting a suggested correction for the original query). The query-correction pairs can be analyzed to generate a probabilistic model, such as a phrase table that indicates matching bi-phrases from the query-correction pairs and estimated probability values for those bi-phrases. The probabilistic model may be used by a spelling correction system. For example, a probability value between a new query and a correction candidate for the new query can be generated using the probabilistic model. For example, this may include using the probabilistic model to calculate probabilities of one or more bi-phrases from the new query and the correction candidate. The probability value between the new query and the correction candidate may be used to select a query correction, such as a spelling correction, for the new query. For example, the probability value may be used to calculate one of multiple features in a ranker-based speller system for query correction.

The subject matter defined in the appended claims is not necessarily limited to the benefits or uses described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Techniques described herein with reference to flowcharts may be used with one or more of the systems described herein and/or with one or more other systems. For example, the various procedures described herein may be implemented with hardware or software, or a combination of both. Moreover, for the sake of simplicity, flowcharts may not show the various ways in which particular techniques can be used in conjunction with other techniques.

### I. Exemplary Computing Environment

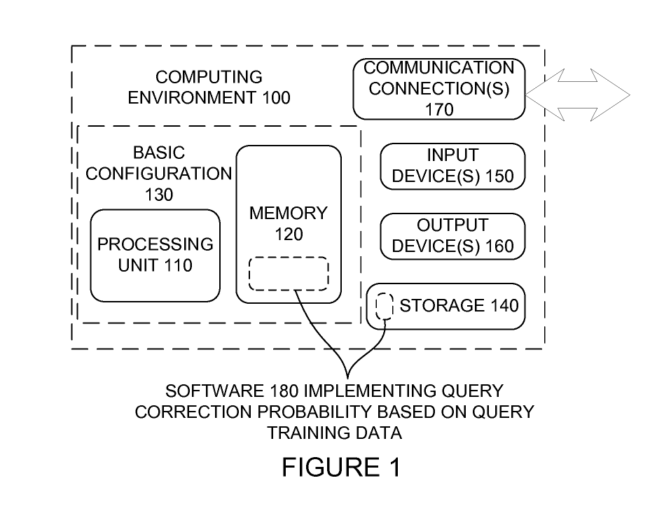

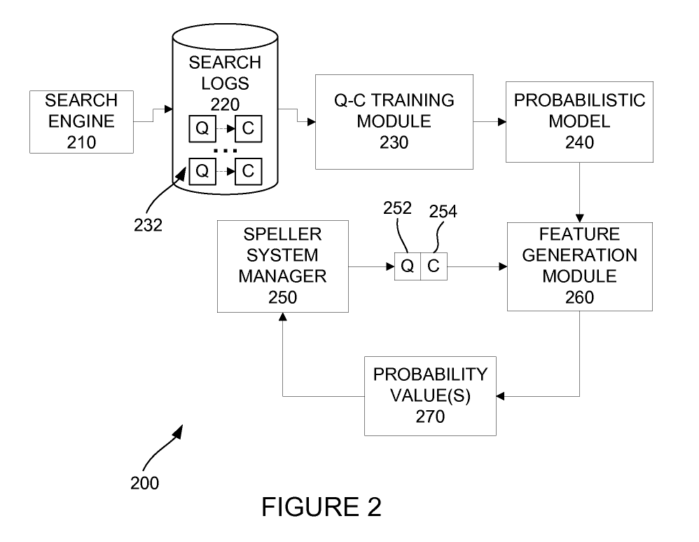

FIG. 1 illustrates a generalized example of a suitable computing environment (100) in which one or more of the described embodiments may be implemented. For example, one or more such environments (100) may be used as a query correction probability system, such as the system and environment described below with reference to FIG. 2. Generally, various different general purpose or special purpose computing system configurations can be used. Examples of well-known computing system configurations that may be suitable for use with the tools and techniques described herein include, but are not limited to, server farms and server clusters, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse general-purpose or special-purpose computing environments.

With reference to FIG. 1, the computing environment (100) includes at least one processing unit (110) and memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The memory (120) may be volatile memory (e.g., registers, cache, RAM), non-volatile memory (e.g., ROM, EEPROM, flash memory), or some combination of the two. The memory (120) stores software (180) that can include one or more software applications implementing query correction probability based on query-correction pairs.

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The storage (140) may be removable or non-removable, and may include non-transitory computer-readable storage media such as magnetic disks, magnetic tapes or cassettes, CD-ROMs, CD-RWs, DVDs, or any other medium which can be used to store information and which can be accessed within the computing environment (100). The storage (140) stores instructions for the software (180).

The input device(s) (150) may be a touch input device such as a keyboard, mouse, pen, or trackball; a voice input device; a scanning device; a network adapter; a CD/DVD reader; or another device that provides input to the computing environment (100). The output device(s) (160) may be a display, printer, speaker, CD/DVD-writer, network adapter, or another device that provides output from the computing environment (100).

The communication connection(s) (170) enable communication over a communication medium to another computing entity. Thus, the computing environment (100) may operate in a networked environment using logical connections to one or more remote computing devices, such as a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media. Computer-readable media are any available media that can be accessed within a computing environment. By way of example, and not limitation, with the computing environment (100), computer-readable media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment. In a distributed computing environment, program modules may be located in both local and remote computer storage media.

For the sake of presentation, the detailed description uses terms like “determine,” “choose,” “adjust,” and “operate” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. Query Correction Probability System and Environment

FIG. 2 is a block diagram of a query correction probability system and environment (200) in conjunction with which one or more of the described embodiments may be implemented. The environment (200) can include a search engine (210), which can supply search logs (220). The search logs (220) can include pairs of original and follow-up queries that were received as user input to the search engine (210). A query-correction training module (230) can analyze the search logs (220) to extract query-correction pairs (232), which are original and follow-up queries that meet specified query-correction criteria applied by the query-correction training module (230). For example, the criteria may include an indication that user input was received indicating that the follow-up query is a correction for the original query. The query-correction training module (230) can analyze the query-correction pairs (232) to generate a probabilistic model (240). The probabilistic model (240) can be stored as a phrase table, which can be in the form of a data structure, such as a TRIE structure. For example, the probabilistic model can represent probabilities of phrase pairs, where a phrase pair includes a phrase from a query and a phrase from a correction. A probability of a phrase pair can represent the probability that one phrase in the pair would be corrected to the other phrase in the pair, or conversely the probability that one phrase in the pair would be the correction for the other phrase in the pair.

Referring still to FIG. 2, a speller system manager (250) can oversee a speller system, such as a speller system for correcting misspelled queries. The speller system manager (250) can supply a new query (252) and a correction candidate or query candidate (254) for that new query (252) to a feature generation module (260). The feature generation module (260) can use the probabilistic model (240) to generate one or more probability values (270), which represent the probability that the correction candidate (254) is actually the correction for the new query (252). The probability values (270) can be used by the speller system manager (250) in selecting a correction for the new query (252), such as by using the probability values (270) as features in a ranker-based speller system.

### III. Detailed Query Correction Probability Implementation

An implementation of a system for calculating and using query correction probabilities will now be described in several sections. This may use one or more components of the environment of FIG. 2 and/or one or more other systems and/or environments.

A. Getting Search Log Data and Extracting Query-Correction Pairs

This section describes an example of how query-correction pairs can be extracted from search log clickthrough data. Different types of clickthrough data from queries may be extracted.

As a first example, clickthrough data may include a set of query sessions that were extracted from one year of log files from a commercial Web search engine. A query session contains a query issued by a user and a ranked list of links (i.e., URLs) returned to that same user along with records of which URLs were clicked. The data can be analyzed to extract pairs of queries Q1 (original query) and Q2 (follow-up query) such that (1) Q1 and Q2 appear to have been issued by the same user (e.g., as indicated by both queries coming from the same IP address or both queries coming in the same browser session); (2) Q2 was issued within 3 minutes of Q1; and (3) Q2 contained at least one clicked URL in the result page (i.e., user input was received selecting at least one item from the results returned for Q2) while Q1 did not result in any clicks. Each such query pair (Q1, Q2) can be analyzed using the edit distance between Q1 and Q2, and those with an edit distance score lower than a pre-set threshold can be identified as query-correction pairs. However, pairs extracted in this manner can suffer from too much noise for reliable error model training, and they may not produce significant improvements in query correction.

As a second example, Clickthrough data can include a set of query reformulation sessions, such as sessions extracted from 3 months of log files from a commercial Web browser. A query reformulation session can include a list of URLs that record user behaviors that relate to the query reformulation functions, provided by a Web search engine. For example, almost all commercial search engines offer the “did you mean” function, suggesting a possible alternate interpretation or spelling of a user-issued query. Following is a sample of the query reformulation sessions that record the “did you mean” sessions from two of the most popular search engines:

Yahoo:
http://search.yahoo.com/search;_ylt=A0geu6ywckBL_XIBSDtXNyoA?p=harrypotter+sheme+park&fr2=sb-top&fr=yfp-t-701&sao=1
http://search.yahoo.com/search?ei=UTF-8&fr=yfp-t-701&p=harry+potter+theme+park&SpellState=n-2672070758_q-
tsI55N6srhZa.qORA0MuawAAAA%40%40&fr2=sp-top
Bing:
http://www.bing.com/search?q=harrypotter+sheme+park&form=QBRE&qs=n
http://www.bing.com/search?q=harry+potter+theme+park&FORM=SSRE

These sessions encode the same user behavior: A user first queries for “harrypotter sheme part”, and then clicks on the resulting spelling suggestion “harry potter theme park”. The parameters from the URLs of these sessions can be analyzed to deduce how each search engine encodes both a query and the fact that a user arrived at a URL user behavior: A user first queries for “harrypotter sheme part”, and then clicks on the resulting spelling suggestion “harry potter theme park”. Accordingly, in extracting query-correction pairs, the parameters from the URLs of these sessions can be analyzed to deduce how each search engine encodes both an original query and the fact that a user arrived at a URL by clicking on the spelling suggestion of the query to provide a follow-up query. This can be a reliable indicator that the spelling suggestion was desired. In one instance, from three months of query reformulation sessions from a commercial search engine, about 3 million such query-correction pairs could be extracted. Compared to the pairs extracted from the clickthrough data of the first type (query sessions), this data set can be less noisy because all these spelling corrections are actually clicked, and thus judged implicitly by user input received from users.

In addition to the “did you mean” function, recently some search engines have introduced two new spelling suggestion functions. One is the “auto-correction” function, where the search engine is confident enough to automatically apply the spelling correction to the query and execute it to produce search results for the user. Another is the “split pane” result page, where one portion of the search results are produced using the original query, while the other (usually visually separate) portion of results are produced using the auto-corrected query.

In neither of these functions is user input provided to approve or disapprove of the correction. Accordingly, the query reformulation sessions recording either of the two functions may be ignored when extracting the query-correction pairs. Although by doing so some basic, easily-identified spelling corrections may be missed, from experiments it appears that the negative impact on error model training is negligible when the clickthrough data model is utilized with another baseline system, such as in a ranking speller with other ranking features. This may be because other features of the speller may already be able to correct such basic, easily-identified spelling corrections. Accordingly, it is believed that including the data from these other functions may not bring further improvements.

It is believed that the error models trained using the data directly extracted from the query reformulation sessions may suffer from the problem of underestimating the self-transformation probability of a query P(Q2=Q1|Q1), because the training data only includes the pairs where the query is different from the correction. To deal with this problem, the training data can be augmented by including correctly spelled queries, i.e., the pairs (Q1, Q2) where Q1=Q2. First, a set of queries can be extracted from the sessions where no spelling suggestion is presented or clicked on. Second, queries that were recognized as being auto-corrected by a search engine can be removed. This can be done by running a sanity check of the queries against a baseline spelling correction system. For example, the baseline spelling correction system may use the source-channel model of Equations 2 and 3. A linear ranker can be used, where the ranker may have only two features, derived respectively from the language model and the error model. The error model can be based on the edit distance function. If the baseline system already identifies an input query as misspelled, it may be assumed that the misspelling was easily-identified, and the query can be removed from the data. The remaining queries can be assumed to be correctly spelled, and can be added to the training data as query-correction pairs where the query is the same as the correction.

B. Ranker-Based Speller System and Using Error Model for Spelling

The spelling correction problem may be formulated under the framework of the source channel model. Given an input query Q=q_{I} . . . q_{I} (where Q is a query with phrases q_{I} to q_{I}) it can be desirable to find the most probable spelling correction C=c₁ . . . c_{J} (where C is a correction with phrases c₁ to c₁) among all candidate spelling corrections:

$${C}^{*} = {arg max}_{c} P ( C \vert Q ) \qquad Equation 1$$

Here, P(C|Q) represents the transformation probability from Q to C, or the probability of C being the correct spelling, given Q. Applying Bayes' Rule, but dropping the constant denominator from Bayes' Rule yields the following:

$${C}^{*} = {arg max}_{c} P ( C \vert Q ) P ( C ) \qquad Equation 2$$

Here, the error model P(Q|C) models the transformation probability from C to Q, and the language model P(C) models how likely C is a correctly spelled query.

The speller system can be based on a ranking model (or ranker), which can be viewed as a generalization of the source channel model. The system can include two components: (1) a candidate generator, and (2) a ranker.

In candidate generation, an input query can be tokenized into a sequence of terms. Then the query can be scanned from left to right, and each query term q can be looked up in a lexicon to generate a list of spelling suggestions c whose edit distance from q is lower than a preset threshold. For example, the lexicon may be a lexicon that contains around 430,000 entries, which are high frequency query terms collected from one year of search query logs. The lexicon can be stored using a tree-based data structure that allows efficient search for all terms within a specified maximum edit distance.

The set of all the generated spelling suggestions can be stored using a lattice data structure, which can be a compact representation of exponentially many possible candidate spelling corrections. A decoder can be used to identify the top twenty candidates from the lattice according to the source channel model of Equation (2). The language model (the second component, or ranker) can be a backoff bigram model trained on the tokenized form of one year of query logs, using maximum likelihood estimation with absolute discounting smoothing. The error model (the first component, or candidate generator) can be approximated by the edit distance function as follows:

−log P(Q|C)αEditDist(Q,C) Equation 3

The decoder can use a standard two-pass algorithm to generate the 20-top-ranked candidates. The first pass can use the Viterbi algorithm to find the top ranked C according to the model of Equations (2) and (3). In the second pass, the A-Star algorithm can be used to find the 20-top-ranked corrections, using the Viterbi scores computed at each state in the first pass as heuristics. The input query Q itself may be included in every 20-top-ranked candidate list.

As noted above, the second component of the speller system can include a ranker, which can re-rank the top twenty candidate spelling corrections. If the top C after re-ranking is different than the original query Q, the speller system can return C as the correction.

A feature vector f can be extracted from a query and candidate spelling correction pair (Q, C). The ranker can map f to a real value y that indicates how likely C is a desired correction of Q. For example, a linear ranker can map f to y with a learned weight vector w such as y=w·f, where w is optimized with respect to accuracy on a set of human-labeled (Q, C) pairs. The features in f can be arbitrary functions that map (Q, C) to a real value. Because the logarithm of the probabilities of the language model and the error model (i.e., the edit distance function) can be defined as features, the ranker can be viewed as a more general framework, subsuming the source channel model as a specific case. For example, 98 features (in addition to those detailed below) and a non-linear model can be used, and the model can be implemented as a two-layer neural net with 5 hidden nodes. The free parameters of the neural net may be trained to optimize accuracy on the training data using the back propagation algorithm, running for 200 iterations with a very small learning rate (0.1) to avoid over-fitting. The system can use features derived from two error models. One can be the edit distance model used for candidate generation. The other can be a phonetic model that measures the edit distance between the metaphones of a query word and its aligned correction word. The system can also use the additional features discussed below.

C. Phrase-Based Error Model

A phrase-based error model discussed in this section can be used to estimate the probability of transforming a correctly spelled query C into a misspelled query Q. Rather than replacing single words in isolation, this model can replace sequences of words with sequences of words, thus incorporating contextual information. For instance, it might be found that “theme part” can be replaced by “theme park” with relatively high probability, even though “part” is not a misspelled word. The following generative story can be used: first the correctly spelled query C can be broken into K non-empty word sequences, or phrases, c₁ . . . , cₖ, then each phrase can be replaced with a new non-empty phrase q₁, . . . , qₖ, and finally these phrases can be permuted and concatenated to form the misspelled Q. Here, c and q can denote phrases, which are consecutive sequences of one or more words.

To formalize this generative process, S can denote the segmentation of C into K phrases c₁ . . . c_{K}, and T can denote the K replacement phrases q₁ . . . q_{K}. These (cᵢ, qᵢ) pairs can be referred to as bi-phrases. Additionally, M can denote a permutation of K elements representing the reordering step. The following table demonstrates an example of this generative procedure.

TABLE 1

| VARIABLE | EXAMPLE | DESCRIPTION |
|---|---|---|
| C: | “disney theme park” | Correct Query |
| S: | [“disney”, “theme park”] | Segmentation |
| T: | [“disnee”, “theme part”] | Translation |
| M: | (1→2, 2←1) | Permutation |
| Q: | “theme part disnee” | Misspelled Query |

A probability distribution can be placed over rewrite pairs. B(C, Q) can denote the set of S, T, M triples that transform C into Q. If a uniform probability over segmentations is assumed, then the phrase-based probability can be defined as:

$$P ( Q \vert C ) α {\sum }_{( S , T , M ) ∈ B ( C , Q )}^{ } P ( T \vert C , S ) \cdot P ( M \vert C , S , T ) \qquad Equation 4$$

A maximum can be used to approximate the sum from the equation above, yielding the following representation of the probability of Q, given C:

$$P ( Q \vert C ) \approx {max}_{( S , T , M ) ∈ B ( C , Q )} P ( T \vert C , S ) \cdot P ( M \vert C , S , T ) \qquad Equation 5$$

1. Runtime Phrase-Based Query-Correction Probability Calculation

The discussion above defines a generative model for transforming queries. However, it can be useful to provide scores over existing Q and C pairs which act as features for the ranker, rather than providing new queries. The word-level alignments between Q and C can often be identified with little ambiguity. Thus, the technique can be focused on those phrase transformations consistent with a good word-level alignment.

J can be the length of Q, L can be the length of C, and A=a₁, . . . , a_{J} can be a hidden variable representing the word alignment. Each aᵢ can take on a value ranging from 1 to L indicating its corresponding word position in C, or zero if the ith word in Q is unaligned. The cost of assigning k to aᵢ can be equal to the Levenshtein edit distance between the ith word in Q and the kth word in C, and the cost of assigning 0 to aᵢ can be equal to the length of the ith word in Q. The least cost alignment A* between Q and C can be determined using the A-star algorithm.

When scoring a given candidate pair, the technique can focus on those S, T, M triples that are consistent with the word alignment, which can be denoted as B(C, Q, A*). If two words are aligned in A*, then they can appear in the same bi-phrase (cᵢ, qᵢ) for consistency. Once the word alignment is fixed, the final permutation is determined, so that factor can be discarded from Equation 5 above, producing the following:

$$P ( Q \vert C ) \approx {max}_{( S , T , M ) ∈ B ( C , Q , {A}^{*} )} P ( T \vert C , S ) \qquad Equation 6$$

For the sole remaining factor, P(T|C, S), it can be assumed that a segmented query T=q₁ . . . q_{K} is generated from left to right by transforming each phrase c₁ . . . C_{K} independently, so that P(T|C, S) can be represented as follows:

P(T|C,S)=πₖ₌₁^{K}P(qₖ|cₖ) Equation 7

where P(qₖ|cₖ) is a phrase transformation probability. The estimation of the phrase transformation probability can be performed using the clickthrough data discussed above in a technique to be discussed in the following section (“Extracting Bi-Phrases and Estimating Their Transformation Probabilities”).

To find the maximum probability assignment efficiently, a dynamic programming approach can be used. The technique can be similar to an existing monotone decoding algorithm. However, both the input and the output word sequences can be specified as the input, as can the word alignment. The quantity αⱼ can represent the probability of the most likely sequence of bi-phrases that produce the first j terms of Q and are consistent with the word alignment and C. αⱼ can be calculated using the following technique:

$$\begin{matrix}Initialization \text{:} \\ {α}_{0} = 1 \\ & \begin{matrix} \\ Equation 8\end{matrix} \\ Induction \text{:} \\ {∝}_{j} = {max}_{{j}^{′} < j , q = {q}_{{j}^{′} + 1} … {q}_{j}} \{ {∝}_{j} P ( q \vert {c}_{q} ) \} \\ & \begin{matrix} \\ Equation 9\end{matrix} \\ Total \text{:} \\ P ( Q \vert C ) = {∝}_{j} & \begin{matrix} \\ Equation 10\end{matrix}\end{matrix}$$

Pseudo-code for the above technique can be expressed as follows:

Input: biPhraseLattice “PL” with length = K & height = L;
Initialization: biPhrase.maxProb = 0;
for (x = 0; x <= K − 1; x++)

for (y = 1; y <= L; y++)

for (yPre = 1; yPre <= L; yPre++)
{

xPre = x − y;
biPhrasePre = PL.get(xPre, yPre);
biPhrase = PL.get(x, y);
if (!biPhrasePre ∥ !biPhrase)

continue;

probIncrs = PL.getProbIncrease(biPhrasePre, biPhrase);
maxProbPre = biPhrasePre.maxProb;
totalProb = probIncrs + maxProbPre ;
if (totalProb > biPhrase.maxProb)
{

biPhrase.maxProb = totalProb;
biPhrase.yPre = yPre;

}

}

Result: record at each bi-phrase boundary its maximum
probability (biPhrase.maxProb) and optimal back-tracking
biPhrases (biPhrase.yPre).

After generating Q from left to right according to Equations (8) to (10), at each possible bi-phrase boundary the maximum probability for the bi-phrase can be recorded, and the total probability can be obtained at the end-position of Q. Then, by back-tracking the most probable bi-phrase boundaries, B* (the set of bi-phrases yielding the most probable bi-phrase boundaries) can be obtained. This technique takes a complexity of O(KL²), where K is the total number of word alignments in A* which does not contain empty words, and L is the maximum length of a bi-phrase, which is a hyper-parameter of the technique. Notice that L can be set to a value of one to reduce the phrase-based error model to a word-based error model, which assumes that words are transformed independently from C to Q, without taking into account any contextual information. It is believed that the value of L can affect spell correction performance, and that a value of 3 (maximum bi-phrase length of 3) can provide especially good results, while values in the range from 2 to 8 and even larger values can also provide beneficial results.

2. Extracting Bi-Phrases and Estimating Their Transformation Probabilities

This section discusses the extraction of bi-phrases and estimating their replacement probabilities in query-correction pairs in the search log data used for training. It is believed that the size of the search log data can affect spelling performance. For example, the search log data may include 0.5 month, 1 month, 2 months, 3 months, or even more search log data from a commercial search engine. From each query-correction pair with its word alignment (Q, C, A*), all bi-phrases consistent with the word alignment can be identified. Consistency here can include two things. First, there is at least one aligned word pair in the bi-phrase. Second, there are not any word alignments from words inside the bi-phrase to words outside the bi-phrase. That is, a phrase pair can be excluded from extraction if there is an alignment from within the phrase pair to outside the phrase pair. The toy example shown in the tables below illustrates an example of phrases that can be generated with this technique.

TABLE 2
TOY EXAMPLE OF WORD ALIGNMENT BETWEEN
“adcf” AND “ABCDEF” (“#” Indicates Alignment)

| | A | B | C | D | E | F |
|---|---|---|---|---|---|---|
| A | # | | | | | |
| D | | | | # | | |
| C | | | # | | | |
| F | | | | | | # |

TABLE 3
BI-PHRASES WITH UP TO FIVE WORDS CONSISTENT WITH
WORD ALIGNMENT

| PHRASES FROM | PHRASES FROM |
|---|---|
| “adcf” STRING | “ABCDEF” STRING |
| a | A |
| adc | ABCD |
| d | D |
| dc | CD |
| dcf | CDEF |
| c | C |
| f | F |

After gathering all such bi-phrases from the full training data, conditional relative frequency estimates can be made without smoothing. For example, the phrase transformation probability P(q|c) in Equation (7) can be estimated approximately as follows:

$$P ( q \vert c ) = \frac{N ( c , q )}{{\sum }_{{q}^{′}}^{ } N ( c , {q}^{′} )} \qquad Equation 11$$

where N(c,q) is the number of times that the phrase c is aligned to the phrase q in training data, and Σ_{q′}N(cq′) is the number of times the phrase c is aligned to any phrase in the training data. These estimates can be useful for contextual lexical selection with sufficient training data, but can be subject to data sparsity issues.

An alternate translation probability estimate that is generally not as prone to data sparsity issues is the so-called lexical weight estimate. Consider a word translation distribution t(q|c) (defined over individual words), and a word alignment A between q and c; here, the word alignment contains (i,j) pairs, where iε0 . . . |q| and i=0 . . . |c|, with 0 indicating an inserted word. Then following estimate can be used:

$${P}_{w} ( q \vert c , A ) = {\prod }_{i = 1}^{\vert q \vert} \frac{1}{\vert \{ j \vert ( j , i ) ∈ A \} \vert} {\sum }_{∀ ( i , j ) ∈ A}^{ } t ( {q}_{i} \vert {c}_{j} ) \qquad Equation 12$$

It can be assumed that for every position in q, there is either a single alignment to 0, or multiple alignments to non-zero positions in c. In effect, this computes a product of per-word translation scores; the per-word scores are averages of all the translations for the alignment links of that word. The word translation probabilities can be estimated using counts from the word aligned corpus:

$$t ( q \vert c ) = \frac{N ( c , q )}{{\sum }_{{q}^{′}}^{ } N ( c , {q}^{′} )} .$$

Here N(c,q) is the number of times that the words (not phrases as in Equation 11) c and q are aligned in the training data. These word-based scores of bi-phrases, though not believed to be as effective in contextual selection, are believed to be more robust to noise and sparsity.

The phrase translation probability estimates calculated from the training data according to equations 11 and 12 (two values—one value for each equation—for each phrase pair, or bi-phrase) can be stored in a data structure and used to estimate probabilities between queries and correction candidates, as was discussed in the previous section (“Runtime Phrase-Based Query-Correction Probability Calculation”).

Throughout this section, this model has been approached in a noisy channel approach, finding probabilities of the misspelled query given the corrected query. However, the method can be run in both directions, and in practice it may also be beneficial to include the direct probability of the corrected query given this misspelled query. This can yield two more values for each phrase pair extracted from the training data, and those values can also be stored in the data structure for use in estimating probabilities between queries and correction candidates.

3. Feature Generation

To use the phrase-based error model for spelling correction, five features can be derived. Those features can then be used, such as by integrating the features in a ranker-based query speller system, such as the one described above. Alternatively, the probabilities and/or features may be used in some other manner, such as by using only those probabilities for query spelling correction, or using less than all of the five features. These features can include one or more of the following features.

Two phrase transformation features: These are the phrase transformation scores based on relative frequency estimates in two directions. In the correction-to-query direction, the feature can be defined as fₚₜ(Q,C,A)=log P(Q|C), where P(Q|C) can be computed by Equations 8 to 10, and P(q|c_{q}) is the relative frequency estimate of Equation 11.

Two lexical weight features: These are the phrase transformation scores based on the lexical weighting models in two directions. For example, in the correction-to-query direction, the feature can be defined as f_{lw}(Q,C,A)=log P(Q|C), where P(Q|C) can be computed by Equations 8 to 10, and the phrase transformation probability can be computed as lexical weight according to Equation 12.

Unaligned word penalty feature: The feature can be defined as the ratio between the number of unaligned query words and the total number of query words.

### IV. Query Correction Probability Techniques

Several query correction probability techniques will now be discussed. Each of these techniques can be performed in a computing environment. For example, each technique may be performed in a computer system that includes at least one processor and a memory including instructions stored thereon that when executed by the at least one processor cause the at least one processor to perform the technique (a memory stores instructions (e.g., object code), and when the processor(s) execute(s) those instructions, the processor(s) perform(s) the technique). Similarly, one or more computer-readable storage media may have computer-executable instructions embodied thereon that, when executed by at least one processor, cause the at least one processor to perform the technique.

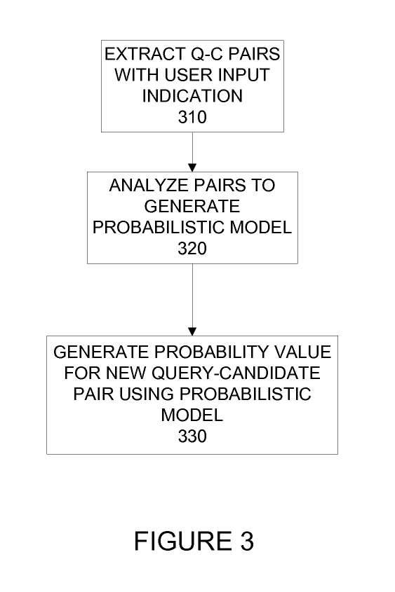

Referring to FIG. 3, a query correction probability technique will be discussed. The technique can include extracting (310) query-correction pairs from search log data based on one or more criteria. The one or more criteria can include for each query-correction pair an indication of an original query in the pair, an indication of a follow-up query in the pair, and an indication of user input indicating the follow-up query is a correction for the original query. The query-correction pairs can be analyzed (320) to generate a probabilistic model. Additionally, a probability value between a new query and a correction candidate for the new query can be generated (330) using the probabilistic model.

The indication of user input can include an indication of user input selecting the follow-up query from one or more suggested queries returned in response to the original query. The indication of user input may include an indication of user input making a selection from results returned from the follow-up query. Additionally, the one or more criteria may further include an indication that user input was not received to make a selection from results returned from the original query; a time between receiving the original query in the pair and the follow-up query in the pair not exceeding a specified maximum time; an edit distance between the original query in the pair and the follow-up query in the pair not exceeding a specified maximum edit distance; and/or an indication that the original query in the pair and the follow-up query in the pair were received from the same user (e.g., the indication may be an indication that both queries came from the same IP address and/or that both queries came in the same browser session).

The probabilistic model can include one or more representations of one or more bi-phrase probabilities, and each bi-phrase probability can represent an estimated probability of a first phrase given a second phrase, based on bi-phrases in the query-correction pairs.

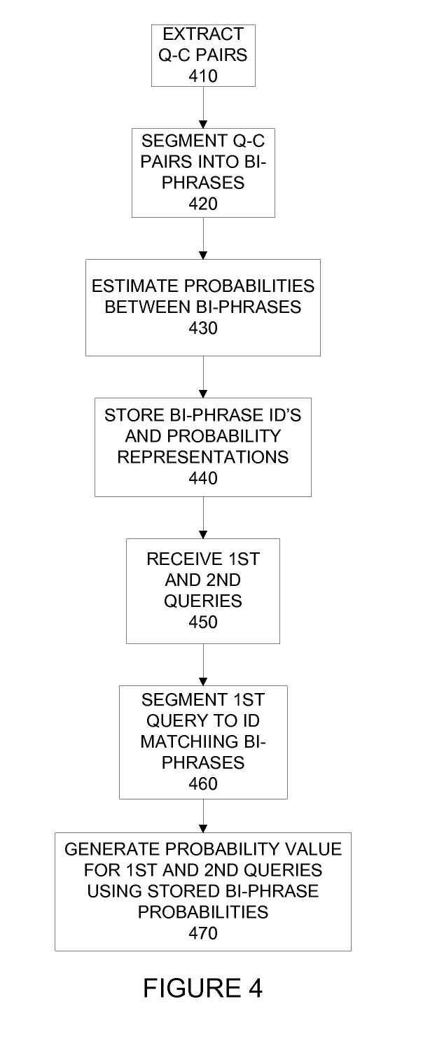

Referring to FIG. 4, another query correction probability technique will be discussed. The technique can include extracting (410) query-correction pairs from a set of search log data, with each query-correction pair including an original query and a follow-up query. The follow-up query in each query-correction pair can be a query that meets one or more criteria for being identified as a correction of the original query in the pair. The technique can also include segmenting (420) the query-correction pairs to identify pairs of bi-phrases in the query-correction pairs, with one or more of the phrases in the bi-phrases including multiple words. In addition, the technique can include estimating (430) probabilities of the bi-phrases in the query-correction pairs. The estimation of probabilities can be based on frequencies of matches between corresponding original phrases in the original queries and follow-up phrases in the follow-up queries in the query-correction pairs. The technique can also include storing (440) identifications of the bi-phrases and representations of the probabilities of those bi-phrases in a probabilistic model data structure.

The one or more criteria for being identified as a correction of the original query can include an indication of user input indicating the follow-up query is a correction for the original query. Also, the indication of user input can include an indication of user input selecting the follow-up query from one or more suggested queries returned in response to the original query.

Segmenting (420) can include aligning words in corresponding query-correction pairs and identifying matching bi-phrases in the query-correction pairs using the alignments between words. Also, segmenting (420) can include imposing a specified maximum number of words allowed in the bi-phrases, such a single word or a number of words, where the number is selected from the group consisting of the numbers 2, 3, 4, 5, 6, 7, and 8.

Estimating (430) probabilities can include calculating for each bi-phrase a number of matches of phrases in the bi-phrase. Estimating (430) probabilities can further include for each pair of corresponding bi-phrases dividing by a number of matches that include a follow-up phrase in the bi-phrase. In addition to or instead of such calculations, estimating (430) probabilities can include for each bi-phrase calculating a number of times that aligned words in the bi-phrase are aligned when segmenting (420) the query-correction pairs.

Referring still to FIG. 4, the technique can further include receiving (450) a first query and a second query. The first query can be received as user input, and the second query can be a correction candidate for the first query. The technique can include segmenting (460) the first query to identify one or more matching bi-phrases between the first and second queries. The bi-phrases can each include a phrase from the first query and a phrase from the second query. Using a probability from the probabilistic model data structure for each of the one or more matching bi-phrases, a probability value can be generated (470). The probability value can represent an estimate of a probability of the second query, given the first query.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/we claim:

1. One or more computer-readable storage media having computer-executable instructions embodied thereon that, when executed by at least one processor, cause the at least one processor to perform acts comprising:
extracting query-correction pairs from search log data based on one or more criteria, the one or more criteria comprising for each query-correction pair an indication of an original query in the pair, an indication of a follow-up query in the pair, and an indication of user input indicating the follow-up query is a correction for the original query;
analyzing the query-correction pairs to generate a probabilistic model; and
generating a probability value between a new query and a correction candidate for the new query using the probabilistic model.

2. The one or more computer-readable storage media of claim 1, wherein the indication of user input comprises an indication of user input selecting the follow-up query from one or more suggested queries returned in response to the original query.

3. The one or more computer-readable storage media of claim 1, wherein:
the indication of user input comprises an indication of user input making a selection from results returned from the follow-up query; and
the one or more criteria further comprise:
an indication that user input was not received to make a selection from results returned from the original query;
a time between receiving the original query in the pair and the follow-up query in the pair not exceeding a specified maximum time;
an edit distance between the original query in the pair and the follow-up query in the pair not exceeding a specified maximum edit distance; and
an indication that the original query in the pair and the follow-up query in the pair were received from the same user.

4. The one or more computer-readable storage media of claim 1, wherein the probabilistic model comprises one or more representations of one or more bi-phrase probabilities, wherein each bi-phrase probability represents an estimated probability of a first phrase given a second phrase, based on bi-phrases in the query-correction pairs.

5. A computer-implemented method, comprising:
extracting query-correction pairs from a set of search log data, with each query-correction pair comprising an original query and a follow-up query, the follow-up query meeting one or more criteria for being identified as a correction of the original query;
segmenting the query-correction pairs to identify bi-phrases in the query-correction pairs, one or more phrases in the bi-phrases comprising multiple words;
estimating probabilities of the bi-phrases in the query-correction pairs, the estimation of probabilities being based on frequencies of matches in the query-correction pairs; and
storing identifications of the bi-phrases and representations of the probabilities of those bi-phrases in a probabilistic model data structure.

6. The method of claim 5, wherein the one or more criteria for being identified as a correction of the original query comprises an indication of user input indicating the follow-up query is a correction for the original query.

7. The method of claim 6, wherein the indication of user input comprises an indication of user input selecting the follow-up query from one or more suggested queries returned in response to the original query.

8. The method of claim 5, wherein segmenting comprises imposing a specified maximum number of words allowed in the bi-phrases.

9. The method of claim 8, wherein the maximum number of words is a number selected from the group consisting of the numbers 2, 3, 4, 5, 6, 7, and 8.

10. The method of claim 5, wherein segmenting comprises aligning words in corresponding query-correction pairs.

11. The method of claim 5, wherein estimating probabilities comprises calculating for each bi-phrase a number of matches of the bi-phrase.

12. The method of claim 11, wherein estimating probabilities further comprises for each bi-phrase dividing by a number of matches that include a follow-up phrase in the bi-phrase.

13. The method of claim 5, wherein estimating probabilities comprises for each bi-phrase calculating a number of times that aligned words in the bi-phrase are aligned when segmenting the query-correction pairs.

14. The method of claim 5, further comprising:
receiving a first query and a second query;
segmenting the first query to identify one or more matching bi-phrases between the first and second queries, the bi-phrases each comprising a phrase from the first query and a phrase from the second query; and
using a probability from the probabilistic model data structure for each of the one or more matching bi-phrases, generating a probability value representing an estimate of a probability between the first and second queries.

15. The method of claim 14, wherein the first query is a query received as user input, and the second query is a correction candidate for the first query.

16. The method of claim 15, wherein
the one or more criteria for being identified as a correction of the original query comprises an indication of user input indicating the follow-up query is a correction for the original query; and
segmenting comprises identifying alignments between words in corresponding query-correction pairs and identifying matching bi-phrases in the query-correction pairs using the alignments between words.

17. One or more computer-readable storage media having computer-executable instructions embodied thereon that, when executed by at least one processor, cause the at least one processor to perform acts comprising:
extracting query-correction pairs from a set of search log data, with each query-correction pair comprising an original query and a follow-up query, the follow-up query meeting one or more criteria for being identified as a correction of the original query, the one or more criteria comprising an indication of user input indicating the follow-up query is a correction for the original query;
segmenting the query-correction pairs to identify bi-phrases in the query-correction pairs, one or more phrases in the bi-phrases comprising multiple words;
estimating probabilities of the bi-phrases in the query-correction pairs, the estimation of probabilities being based on frequencies of matches in the query-correction pairs; and
storing identifications of the bi-phrases and representations of the probabilities of those bi-phrases in a probabilistic model data structure.

18. One or more computer-readable storage media of claim 17, wherein the acts further comprise:
receiving a first query and a second query;
identifying one or more matching bi-phrases between the first and second queries, the bi-phrases each comprising a phrase from the first query and a phrase from the second query; and
using a probability from the probabilistic model data structure for each of the one or more matching bi-phrases, generating a probability value representing an estimate of a probability between the first and second queries.

19. One or more computer-readable storage media of claim 17, wherein the indication of user input comprises an indication of user input selecting the follow-up query from one or more suggested queries returned in response to the original query.

20. One or more computer-readable storage media of claim 17, wherein estimating probabilities comprises calculating for each bi-phrase a number of matches of the bi-phrase.
